(19) United States
(12) Patent Application Publication
(10) Pub. No.: US 2026/0185860 A1
(43) Pub. Date: Jul. 2, 2026

(54) FUEL TRACKING SYSTEM FOR AUTOMATED CHAIN-OF-CUSTODY TRACKING AND THEFT PREVENTION IN EQUIPMENT RENTALS

(71) Applicant: EQUIPMENTSHARE.COM INC., Columbia, MO (US)

(72) Inventors: Brian Adams, Columbia, MO (US); Levi Casey, Columbia, MO (US)

(21) Appl. No.: 19/006,663

(22) Filed: Dec. 31, 2024

(51) Int. Cl. G01F 15/00; G01F 1/56; G01F 15/063

(52) U.S. Cl. CPC G01F 15/001; G01F 1/56; G01F 15/063

(57) ABSTRACT

A fluid tracking system and system use a reader device to read asset identification devices coupled to equipment assets to obtain unique asset identifiers. Data including amounts of fluid dispensed to the equipment assets and the unique asset identifiers are received. Custody of the fluid from the one or more fluid dispensers to the equipment assets is tracked for monitoring the amounts of the fluid dispensed to the equipment assets. One or more of (a) theft of the fluid and/or (b) a fault with the equipment assets or engines of equipment assets is identified based on the custody of the fluid that is tracked.

### TECHNICAL FIELD

The subject matter described herein relates to fluid management systems, specifically to systems and methods for tracking and monitoring fluid distribution to equipment assets, such as fuel, lubricants, or the like, to rental equipment.

### BACKGROUND

Fuel management systems encompass technologies and methodologies for tracking, monitoring, and controlling the distribution and usage of fuel. These systems are used in transportation, construction, and rental service industries, and can be used to reduce fuel theft and improve the accuracy of records of fuel consumption.

One of the primary challenges in fuel management for equipment rental services is ensuring the accurate tracking of fuel distribution to different equipment assets. Personnel may fail to input the correct information, leading to discrepancies in fuel records. Furthermore, there is a risk of fuel theft, where customers may use fuel intended for rental equipment for personal purposes. Another challenge is the inability to track the amount of fuel distributed to multiple assets when a fuel truck services several pieces of equipment at a job site. For example, at some job sites, a fuel truck may be loaded with fuel from a fuel dispenser (e.g., a stationary tank or fuel pump) and transport the fuel to the job site. At the job site, the fuel truck may dispense different amounts of fuel to different equipment assets at the job site. It may be difficult to accurately track the amounts of fuel delivered in such a way as the fuel truck may not have equipment onboard to monitor the dispensing of fuel. Additionally, there is a need to prevent customers from using the wrong type of fuel in different equipment assets, which can cause damage and operational issues to the rental equipment assets.

Some known fuel management systems rely on manual entry of data, such as by personnel inputting codes into a keypad at or near the fuel pump. This manual entry of data can lead to errors and inaccuracies. These systems may not provide comprehensive tracking of fuel distribution, including the identification of the equipment and personnel involved.

Additionally, current systems may lack the capability to effectively detect and prevent fuel theft. For example, personnel that are refueling rental equipment assets may improperly dispense some fuel intended (or sold) for the rental equipment assets into personal vehicles, equipment, or containers of the personnel. Furthermore, there is often no mechanism to ensure that the correct type of fuel is used for each equipment asset other than differently sized fuel nozzles for different fuels, leading to potential operational issues and equipment damage.

### BRIEF SUMMARY

In one example, a fluid tracking system includes a reader device configured to read a plurality of asset identification devices. The asset identification devices include a first asset identification device coupled to a first equipment asset and a second asset identification device coupled to a second equipment asset. The first equipment asset and the second equipment asset are different from each other. The first asset identification device can obtain a first unique asset identifier from the first equipment asset. The second asset identification device can obtain a second unique asset identifier from the second equipment asset that differs from the first unique asset identifier. The tracking system also can include a controller that receives data including a first amount of fluid dispensed to the first equipment asset from one or more fluid dispensers, a second amount of the fluid dispensed to the second equipment asset from the one or more fluid dispensers, the first unique asset identifier, and the second unique asset identifier. The controller can track custody of the fluid from the one or more fluid dispensers to the first equipment asset and to the second equipment asset for monitoring the first amount of the fluid dispensed to the first equipment asset and for monitoring the second amount of the fluid dispensed to the second equipment asset. The controller can identify one or more of (a) theft of the fluid and/or (b) a fault. The fault is with the first equipment asset, with the second equipment asset, with a first engine of the first equipment asset, or with a second engine of the second equipment asset based on the custody of the fluid that is tracked.

The one or more fluid dispensers can include a fuel vehicle that hauls fuel as the fluid from a stationary fuel pump station to a remote location where the first equipment asset and the second equipment asset are located. The reader device can be coupled with the fuel vehicle to read the asset identification devices and obtain the first unique asset identifier and the second unique asset identifier at the remote location. The system also can include a nozzle sensor coupled with the fuel vehicle.

The nozzle sensor can measure the first amount of the fluid dispensed to the first equipment asset and the second amount of the fluid dispensed to the second equipment asset. The nozzle sensor directly or indirectly outputs the amounts of the fluid dispensed to the controller.

The nozzle sensor can measure one or more characteristics of the nozzle or the fluid. The controller can determine whether any of the fluid dispensed from the one or more fluid dispensers is dispensed to a non-equipment asset based on the one or more characteristics. The controller can determine whether the fluid that is dispensed to a non-equipment asset is stolen, dispensed into a container other than the first equipment asset and or the second equipment asset, or dispensed into equipment or a vehicle other than the first equipment asset and the second equipment asset based on the one or more characteristics.

The nozzle sensor can include an accelerometer that measures movements of the nozzle as the one or more characteristics. The controller can examine the movements of the nozzle that are measured to determine whether (a) the nozzle moved from at least one of the fluid dispensers to the first equipment asset or the second equipment asset to dispense the fluid and then back to the at least one of the fluid dispensers or (b) the nozzle moved from at least one of the first equipment asset or the second equipment asset and then to the non-equipment asset to dispense the fluid before being returned to the at least one of the fluid dispensers.

The nozzle sensor can include a pressure sensor that measures fluid pressures within one or more of the nozzle or a hose connecting the nozzle to at least one of the fluid dispensers as the one or more characteristics. The controller can examine the fluid pressures to determine whether (a) the nozzle moved from at least one of the fluid dispensers to the first equipment asset or the second equipment asset to dispense the fluid and then back to the at least one of the fluid dispensers or (b) the nozzle moved from at least one of the first equipment asset or the second equipment asset and then to the non-equipment asset to dispense the fluid before being returned to the at least one of the fluid dispensers.

The nozzle sensor can include a flow rate sensor that measures rates of fluid flow out of the nozzle as the one or more characteristics. The controller can examine the rates of fluid flow to determine whether (a) the nozzle moved from at least one of the fluid dispensers to the first equipment asset or the second equipment asset to dispense the fluid and then back to the at least one of the fluid dispensers or (b) the nozzle moved from at least one of the first equipment asset or the second equipment asset and then to the non-equipment asset to dispense the fluid before being returned to the at least one of the fluid dispensers.

The controller can track the amounts of the fluid dispensed to each of the first equipment asset and the second equipment asset. The controller can communicate with the first equipment asset and the second equipment asset to monitor usage of the first equipment asset and the second equipment asset. The controller can identify potential theft of the fluid by comparing the amounts of the fluid dispensed to each of the first equipment asset and the second equipment asset with the usage of each of the first equipment asset and the second equipment asset.

The controller can identify one or more of the first equipment asset or the second equipment asset as in need for repair, maintenance, or inspection by comparing the amounts of fluid dispensed to each of the first equipment asset and the second equipment asset with the usage of each of the first equipment asset and the second equipment asset.

The controller can identify a type of the fluid that each of the first equipment asset and the second equipment asset can use from the first unique asset identifier and the second unique asset identifier read by the reader device. The controller can control a fluid nozzle to prevent dispensing of the fluid to at least one of the first equipment asset or the second equipment asset responsive to determining that the fluid is different from the fluid type usable by the at least one of the first equipment asset or the second equipment asset.

In another example, a method for tracking distribution of fluid includes reading a first asset identification device coupled to a first equipment asset using a reader device to obtain a first unique asset identifier of the first equipment asset, reading a second asset identification device coupled to a second equipment asset using the reader device to obtain a second unique asset identifier of the second equipment asset, the second equipment asset being different from the first equipment asset, receiving, at a controller, a first amount of the fluid dispensed to the first equipment asset from one or more fluid dispensers and the first unique asset identifier, receiving, at the controller, a second amount of the fluid dispensed to the second equipment asset from the one or more fluid dispensers and the second unique asset identifier, tracking custody of the fluid from the one or more fluid dispensers to the first equipment asset and to the second equipment asset for monitoring the first amount of the fluid dispensed to the first equipment asset and for monitoring the second amount of the fluid dispensed to the second equipment asset, and identifying one or more of (a) theft of the fluid or (b) a fault with the first equipment asset, with the second equipment asset, with a first engine of the first equipment asset, or with a second engine of the second equipment asset based on the custody of the fluid that is tracked.

The one or more fluid dispensers can include a fuel vehicle configured to haul fuel from a stationary fuel pump station to a remote location where the first equipment asset and the second equipment asset are located. The reader device can be coupled with the fuel vehicle to read the first asset identification device and the second asset identification device, and to obtain the first unique asset identifier and the second unique asset identifier at the remote location. The method also can include measuring the first amount of the fuel dispensed to the first equipment asset and the second amount of the fuel dispensed to the second equipment asset at the remote location using a nozzle sensor, and directly or indirectly communicating the first amount of the fuel and the second amount of the fuel to the controller from the nozzle sensor.

The method also can include measuring one or more characteristics of a nozzle that dispenses the fluid or of the fluid using a nozzle sensor, and determining whether the first amount of the fluid and the second amount of the fluid that is dispensed from the one or more fluid dispensers is dispensed to at least one of the first equipment asset, the second equipment asset, or to a non-equipment asset based on the one or more characteristics.

The one or more characteristics include movements of the nozzle measured using an accelerometer. The method also can include examining the movements of the nozzle that are measured to determine whether (a) the nozzle moved from at least one of the fluid dispensers to the first equipment asset or the second equipment asset to dispense the fluid and then back to the at least one of the at least one of the fluid dispensers or (b) the nozzle moved from at least one of the first equipment asset or the second equipment asset then to the non-equipment asset to dispense the fluid before being returned to the at least one of the fluid dispensers.

The one or more characteristics can include fluid pressures within one or more of a nozzle or a hose connecting the nozzle to at least one of the fluid dispensers. The method also can include examining the fluid pressures to determine whether (a) the nozzle moved from at least one of the fluid dispensers to the first equipment asset or the second equipment asset to dispense the fluid and then back to the at least one of the fluid dispensers or (b) the nozzle moved from at least one of the first equipment asset or the second equipment asset to the non-equipment asset to dispense the fluid before being returned to the at least one of the fluid dispensers.

In another example, a fluid tracking system includes a reader device coupled with a fluid dispenser to interrogate an asset identification device to obtain a unique asset identifier of a rental equipment asset, an input device coupled with the fluid dispenser that receives a personnel identifier that uniquely identifies a person that distributed fluid to the rental equipment asset from the fluid dispenser, a nozzle sensor coupled with a nozzle of the fluid dispenser from which the fluid is dispensed that monitors one or more characteristics of the nozzle or the fluid dispensed from the nozzle, and a controller that receives the unique asset identifier, the personnel identifier, and the one or more characteristics of the nozzle or the fluid to track an amount of fluid dispensed to the rental equipment asset and determine whether a portion of the fluid dispensed from the fluid dispenser is stolen.

The controller can identify a usable type of the fluid that the equipment asset can use based on the unique asset identifier. The controller can change a state of a value coupled with the nozzle to prevent dispensing of the fluid based on the usable type of the fluid that the equipment asset can use and a dispensed type of the fluid that is dispensed from the fluid dispenser.

The nozzle sensor can measure one or more of movements of the nozzle, fluid pressure within the nozzle or a hose connected to the nozzle, or a rate of flow of the fluid from the nozzle as the one or more characteristics. The controller can determine whether the fluid that is dispensed is stolen, dispensed into a container other than the equipment asset, or is dispensed into equipment or a vehicle other than the equipment asset based on the one or more characteristics

### BRIEF DESCRIPTION OF DRAWINGS

FIG. 1 illustrates one example of a fuel tracking system for monitoring fuel distribution to multiple equipment assets.

FIG. 2 illustrates another example of a fuel tracking system for monitoring fuel distribution to multiple equipment assets.

FIG. 3 illustrates a flow chart illustrating one example of a method for tracking and controlling the dispensing of fuel to equipment assets.

FIG. 4 illustrates another example of a fuel tracking system.

FIG. 5 presents a flow chart diagram depicting a method for correlating fuel dispensed, fuel stored, and asset usage to identify potential theft or maintenance needs.

### DETAILED DESCRIPTION

Tracking distribution of fluids such as fuel, lubricants, or the like, to various equipment assets can have significant challenges, particularly when the equipment assets include rental equipment that is rented to multiple customers across different locations or job sites. When rental equipment is returned, personnel at the rental facility or lessor may fill tanks or reservoirs of the rental equipment and fill (or “top off”) the tanks with fluid until the tanks or reservoirs are full. These personnel may manually input information such as identifying details about the personnel adding fluid to the rental equipment asset and the rental equipment asset itself. This manual input process often involves entering user identification data, authentication data, or other data into a keypad or other input device, which can lead to several issues, including the misidentification of which asset received fluid and the amount of fluid dispensed. Errors in manual data entry, especially when using a keypad, can result in discrepancies in fluid tracking records, making accurate tracking of fluid distribution and usage challenging.

While some examples are described herein in connection with tracking the distribution of fuel (e.g., diesel fuel, gasoline, or the like), not all examples are limited to tracking fuel distribution unless expressly limited in that way. Otherwise, the same examples may be used to track the distribution of other fluids, such as lubricants for engines.

Manual input also poses the risk of failing to associate the fluid dispensed with the specific personnel responsible for the filling process. This lack of association can hinder accountability and transparency, as determining who dispensed the fuel and to which equipment asset becomes difficult. Such issues can complicate the invoicing process, leading to potential financial losses and disputes with customers.

Additionally, the absence of accurate tracking can increase the risk of fluid theft or misuse, as unauthorized personnel may dispense the fluid without proper oversight. For example, some job sites where rental equipment is located may have stationary or mobile fuel dispensers (e.g., stationary fuel pumps or fuel tanks and pumps onboard a fuel truck). Rental customers may use these fuel dispensers on their own to refill tanks of the rental equipment at the job sites. But reliance on the customers to dispense fuel in this manner raises the risk of fuel theft. The customers may divert fuel intended for rental equipment for personal use, leading to financial losses. Additionally, when a truck loaded with fuel travels to a job site to fill multiple assets, there may not be any established method to track the exact amount of fuel distributed to each asset, as well as which asset received the fuel. This lack of traceability further exacerbates the issue of fuel theft and misallocation.

Additionally, ensuring that equipment renters do not put the wrong fuel into rental equipment assets is important for maintaining the equipment. Incorrect fuel types can cause significant damage to the engine and other components, leading to costly repairs and downtime.

The disclosed fluid tracking systems and methods described herein address these challenges by providing a comprehensive solution for tracking the chain-of-custody of fluid distributed to equipment assets. The equipment assets described herein can include a variety of different types of assets that consume or use fluid such as fuel or lubricant to operate. The equipment assets can be rental equipment used in various industries, such as construction, agriculture, landscaping, and more. Examples of rental equipment assets include excavators, loaders, backhoes, generators, compactors, forklifts, some aerial lifts, trenchers, concrete mixers, skid steers, and the like. In some embodiments, the rental equipment assets can include vehicles (e.g., rental cars, trucks, vans, etc.) or other equipment that consumes fuel or uses lubricants to operate.

The systems include a reader device that reads asset identification devices coupled to equipment assets to obtain asset identifiers for each asset. A controller receives data on the amounts of fluid dispensed, asset identifiers, and personnel identifiers to be able to track the custody of the fluid from dispensers to the equipment assets. This system ensures accurate monitoring of fluid distribution and the personnel involved in the process for accountability purposes. The integration of the reader device to acquire information from asset identification devices coupled to the equipment assets allows for the automatic acquisition of unique asset identifiers (or at least eliminates the need for manual entry of the identifiers). This reduces the need for manual entry, reduces the likelihood of human error, and increases accurate identification of each equipment asset receiving the fluid.

The ability of the controller to receive data including the amounts of fluid dispensed, unique asset identifiers, and personnel identifiers enables comprehensive tracking of fluid distribution. By associating the dispensed fluid with specific equipment assets and the personnel involved, the system provides a clear chain-of-custody for the fuel. This detailed tracking helps in accurate invoicing and avoidance of fluid theft, as it ensures that the correct amount of fluid is billed to the appropriate customer or rental contract.

Monitoring the amounts of fluid dispensed to each equipment asset and the personnel that dispensed the fluid enhances accountability and transparency in fluid distribution. This feature helps in identifying any discrepancies or irregularities in fluid usage, which can be indicative of fluid theft or misuse. By tracking the personnel involved, the system can also deter unauthorized fluid dispensing and ensure that only authorized personnel are involved in the filling process.

The system's capability to track custody of the fluid from the fluid dispensers to each of the equipment assets provides a robust mechanism for preventing fluid theft and ensuring that fluid is used for its intended purpose. This is particularly valuable in rental services where fluid theft can lead to significant financial losses. The system's comprehensive tracking and monitoring features help in maintaining operational efficiency and reducing the risk of fuel-related issues.

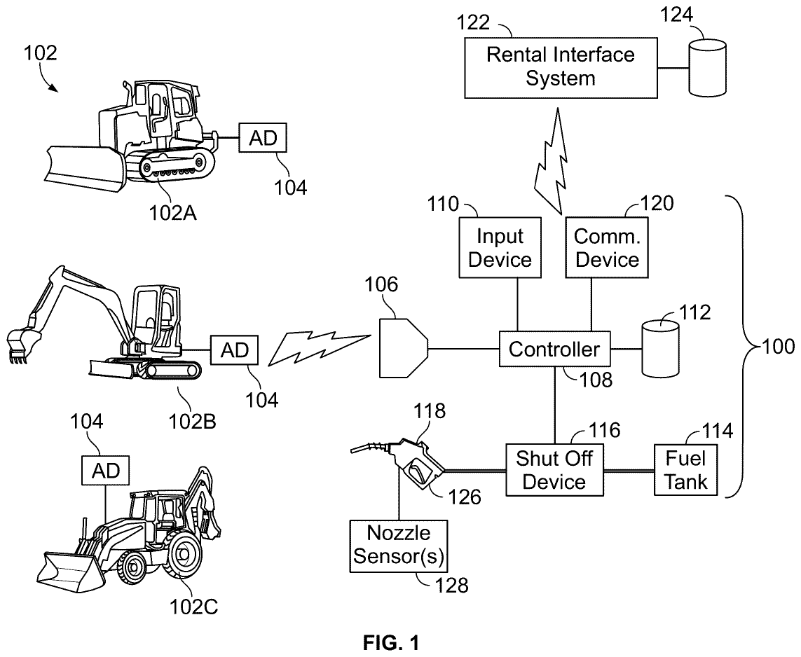

FIG. 1 illustrates one example of a fluid tracking system 100 for monitoring fluid distribution to multiple equipment assets. The fluid distribution tracking system 100 includes several interconnected components designed to ensure accurate tracking and monitoring of fuel distribution to equipment assets 102. The equipment assets 102 represent various machinery or vehicles that require fluids for operation (e.g., at construction sites). Each equipment asset, such as the first equipment asset 102A, second equipment asset 102B, and third equipment asset 102C, is equipped with an asset identification device 104. The asset identification device 104 provides identification for each equipment asset, facilitating precise tracking of fluid distribution. While three equipment assets 102 are shown, there may be many more equipment assets 102. For example, the equipment assets 102 may include some or all of the equipment assets contained within a rental yard, some of all of the equipment assets contained within a fleet of one or more than one customer, or otherwise.

The reader device 106 is configured to read information from the asset identification devices 104 coupled to the equipment assets 102. The reader device 106 can represent one or more than one radio frequency identification (RFID) readers, optical sensors, or radio transceivers to obtain information from the asset identification devices 104.

The asset identification devices 104 can represent RFID tags, bar codes, QR codes, or other scannable identifiers that can be read, interrogated, or scanned by the reader devices 106. In one example, the asset identification devices 104 can be adhered to, affixed on, printed on, etc., the equipment assets 102 at or near the fueling location where the equipment assets 102 receive nozzles 118 to receive the fuel. In one example, the asset identification devices 104 can be integrated into an equipment asset tracker (not shown) that is adhered to or affixed on the equipment assets 102. The reader device 106, which can utilize various technologies such as RFID readers, optical sensors, or radio transceivers, scans the asset identification devices 104 to capture the unique identifiers of the equipment assets 102. This automated process eliminates the need for manual data entry of this information, reducing the likelihood of human error and ensuring accurate identification of each equipment asset receiving fuel. By accurately identifying the equipment assets 102, the system 100 can track the distribution of fuel, monitor usage, and/or ensure that the correct type of fuel is dispensed.

In one example, the reader device 106 may be part of or coupled with the nozzle 118 and the asset identification device 104 can be connected to the asset 102 at or near the fuel filler neck or fuel filler port in the asset 102. This can allow the personnel to quickly and easily read the data from the asset identification device 104 with the reader device 106 without requiring multiple additional steps or operations (e.g., grab and scan with the reader device 106, return the reader device 106 to a resting location, then grab and use the nozzle 118 to dispense fuel).

In some embodiments, the input device 110 allows personnel to input data manually. This input device 110 can include a keypad, touchscreen, or other input mechanisms. In one example, the input device 110 can communicate with a mobile phone, tablet computer, or the like, to receive the input data (e.g., wirelessly, such as via a BLUETOOTH communication, infrared communication, Wi-Fi communication, ZIGBEE communication, RFID communication, cellular communication, infrared communication, Z-wave communication, near field communication (NFC), radio communication, etc.). The input device 110 provides an additional layer of data entry, ensuring that all relevant information is captured. For example, the personnel that is filling a tank of an equipment asset 102 with fuel may use the reader device 106 to scan the asset identification device 104 and obtain the unique asset identifier, but may use the input device 110 to input a personnel identifier that uniquely identifies the personnel using the system 100. This can help with accountability by associating the personnel with the asset 102 and the refueling event. In some embodiments, the reader device 106 can obtain the personnel identifier by reading that information from another device (such as a tag worn or carried by the personnel, from a connect to the mobile device associate with the personnel, or otherwise).

A tangible and non-transitory computer readable storage medium, or memory 112, can store data related to fuel distribution. The memory 112 can represent one or more than one memories, such as random access memory (RAM), flash memory, virtual memory, magnetic memory (e.g., hard disk drives (HDDs), magnetic tapes, etc.), optical memory, or the like. Information stored in the memory 112 can include the asset identifiers read by the reader device 106, the personnel identifiers, the amounts of fuel dispensed from a fuel tank 114 to the different equipment assets 102, the type of fuel stored in the fuel tank 114, etc. The memory 112 can ensure that the data is retained for future reference and analysis, facilitating accurate record-keeping and reporting.

The fuel tank 114 stores the fuel to be dispensed to the equipment assets 102. The fuel tank 114 is connected to the fuel nozzle 118 by hoses or conduits 126, which is used to dispense fuel into the equipment assets 102. The fuel tank 114 ensures that a sufficient supply of fuel is available for distribution, supporting the operational needs of the equipment assets 102. In one example, the fuel tank 114 and fuel nozzle 118 are parts of a stationary fuel pump system. In some embodiments, the fuel tank 114 and fuel nozzle 118 may be parts of a mobile fuel pump system, as described herein. In some embodiments, the fuel tank 114 may be a reservoir for lubricant (e.g., a reservoir for engine oil).

A controller 108 of the system 100 can represent hardware circuitry that includes and/or is connected with one or more processors (e.g., integrated circuits, application-specific integrated circuits, field programmable gate arrays, microprocessors, or the like) that perform the operations described in connection with the controller 108. The controller 108 receives input such as the asset identifier from the reader device 106 and/or the personnel identifier from the reader device 106 or the input device 110.

If the controller 108 does not receive either the asset identifier or the personnel identifier, or if the identifiers do not match the data stored in the memory 112, the controller 108 can activate a shut off device 116. The shut off device 116 can be integrated with the fuel nozzle 118 or can be disposed between the fuel tank 114 and the nozzle 118. The shut off device 116 can be controlled to lock the nozzle 118 and prevent fuel from being dispensed out the nozzle 118. The shut off device 116 can ensure that fuel is only dispensed to authorized equipment assets 102 and by authorized personnel. This can increase the security and accuracy of the fuel distribution process. The shut off device 116 can represent one or more than one valves controlled by the controller 108 to open (to dispense fuel or lubricant) or close (to stop or prevent dispensing of fuel or lubricant). In some embodiments, the shut off device 116 represents one or more than one pumps that operate to dispense the fuel or lubricant. The pump(s) can be deactivated (or turned off) by the controller 108 to stop or prevent dispensing of fuel or lubricant, and also can be activated (or turned on) by the controller 108 to dispense fuel or lubricant.

The controller 108 can both track the amounts of fuel dispensed to the different equipment assets 102, as well as ensure that fuel is only dispensed to authorized equipment assets 102 and/or by authorized personnel. In one example, before fuel can be dispensed from the fuel tank 114 via the nozzle 118, the controller 108 receives both the asset identifier and the personnel identifier. The controller 108 can cross-reference the received identifiers with stored data in the memory 112 to verify the authenticity and authorization of both the equipment asset 102 to receive the fuel and the personnel to dispense the fuel. For example, the asset identifiers associated with equipment assets 102 rented to a lessee and permitted to refuel the equipment assets 102 may be stored in the memory 112. Additionally, personnel identifiers of personnel allowed to dispense fuel into the equipment assets 102 may be stored in the memory 112. If the identifiers received from the reader device 106 and/or the input device 110 match the stored data, the controller 108 allows the nozzle 118 to dispense the fuel. Otherwise, the controller 108 controls the shut off device 116 to prevent fuel from being dispensed (until matching identifiers are provided).

The controller 108 also can examine this data to track the custody of fuel from the fuel dispenser (e.g., the fuel tank 114) to each of the equipment assets 102. The controller 108 ensures that the correct amount of fuel is associated with the appropriate equipment asset 102 and personnel, thereby increasing accountability and transparency in fuel distribution. The fuel nozzle 118 can include or be connected with one or more than one nozzle sensors 128. The sensor 128 can represent one or more than one flow rate sensors, turbine flow meters, positive displacement flow meters, ultrasonic flow meters, Coriolis flow meters, electromagnetic flow meters, pressure sensors, optical sensors, or the like, which measure the amount (e.g., volume) of fuel that is dispensed to each asset 102. This information can be provided to the memory 112 via the controller 108 to track how much fuel is distributed to each asset 102.

A communication device 120 represents one or more than one modems, transceivers, or the like, which can communicate with a rental interface system 122 via wired and/or wireless connections (e.g., networks, such as the Internet, intranets, etc.). The communication device 120 can use wired or wireless communication protocols to communicate the tracked data (e.g., the asset identifiers, the personnel identifiers, and the amounts of fuel dispensed at each re-fueling event of the assets 102).

The rental interface system 122 can represent one or more than one computers or computerized devices that manage rental contracts and fuel distribution records for the assets 102. The rental interface system 122 can generate reports, track fuel usage, and manage billing information, ensuring that rental customers are accurately invoiced for the fuel used. The rental interface system 122 can interface with another memory 124 that may be similar or identical to the memory 112. The memory 124 can store additional data related to the rental interface system 122, including rental contracts, billing information, and fuel usage records derived from the information provided by the fuel tracking system 100. The memory 124 retains relevant data for reference and analysis, including accurate record-keeping and reporting.

The fuel tracking system 100 can track and record the chain-of-custody of fuel from the fuel tank 114 to each of the assets 102. This chain-of-custody can reflect or represent which assets 102 received fuel, how much fuel each of the assets 102 received, the personnel that dispensed the fuel to each of the assets 102, and in some embodiments times and/or dates of when the fuel was dispensed to each of the assets 102. This information can be recorded in the memory 112 and/or communicated to the rental interface system 122 to allow for proper tracking of the amount(s) of fuel dispensed to different equipment assets 102 rented by different customers.

In one example, the memory 112 can store data on which types of fuel each asset 102 can consume. Responsive to receiving the asset identifier for a fueling event, the controller 108 can access the memory 112 and determine whether the asset 102 can consume or burn the same fuel type that is stored in the tank 114 (and dispensed by the nozzle 118). For example, some assets 102 consume diesel fuel, some assets 102 consume gasoline, some assets 102 consume ethanol, etc. The memory 112 may store data indicative of the type of fuel stored in the tank 114 and dispensed by the nozzle 118. The controller 108 can examine the type of fuel that the asset 102 identified by the asset identifier (received via the reader device 106), and compare this type of fuel with the type of fuel stored in the tank 114. If these types of fuel match or are the same, the controller 108 can deactivate or open the shut off device 116 to allow fuel to be dispensed.

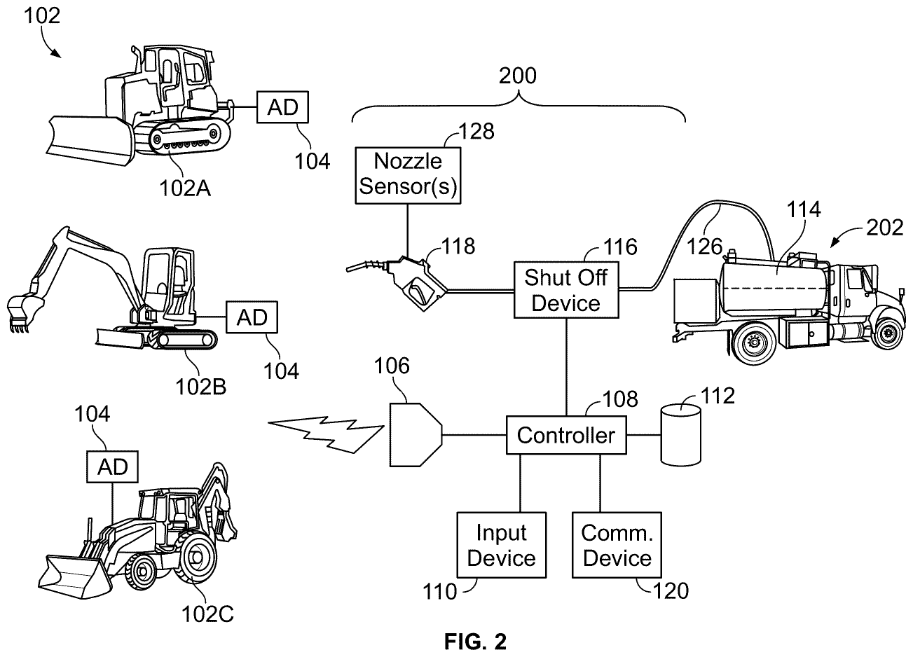

FIG. 2 illustrates another example of a fuel tracking system 200 for monitoring fuel distribution to multiple equipment assets 102. Similar to the fuel tracking system 100 shown in FIG. 1, the fuel tracking system 200 in FIG. 2 can include the controller 108, the input device 110, the communication device 120, the memory 112, and the reader device 106, and may communicate or control the shut off device 116 control flow of fuel from the fuel tank 114 to the assets 102 via the nozzle 118.

One difference between the fuel tracking system 100 and the fuel tracking system 200 is that the fuel tank 114, the shut off device 116, and the nozzle are onboard a mobile vehicle 202, such as a fuel truck. Additionally, the controller 108, memory 112, reader device 106, input device 110, and/or communication device 120 also may be onboard the mobile vehicle 202.

The mobile vehicle 202 can haul the fuel from a stationary fuel pump station or tank (e.g., the tank 114 shown in FIG. 1) to a remote location where the equipment assets 102 are located. For example, the equipment assets 102 rented by one lessee may be at a job site where construction is ongoing. This job site may be too far from a refueling location to allow the equipment assets 102 to travel to the location for refueling. Additionally, the renter or lessor of the equipment assets 102 may restrict the lending of the assets 102 to refueling only with the tank 114 on the mobile vehicle 202 or the stationary tank 114 shown in FIG. 1. In another example, the mobile vehicle 202 may be deployed at a construction equipment rental yard that has an insufficient fuel supply of one or more than one fuel types to provide for refueling during a particular time period.

The vehicle 202 provides a mobility to the fuel distribution tracking system 200. This allows the system 200 to refuel multiple equipment assets 102 in remote locations and/or across different locations. In operation, the mobile vehicle 202 travels to the location of one or more than one of the equipment assets 102. As described above, if the controller 108 does not receive either the asset identifier or the personnel identifier, or if the identifiers do not match the data stored in the memory 112, the controller 108 can activate the shut off device 116 to prevent fuel from being dispensed out the nozzle 118. If the identifiers match the stored data, the controller 108 allows the nozzle 118 to dispense the fuel.

The controller 108 can track the amounts of fuel dispensed to the different equipment assets 102, as well as ensure that fuel is only dispensed to authorized equipment assets 102 and/or by authorized personnel. The controller 108 also can examine this data to track the custody of fuel from the fuel dispenser (e.g., the fuel tank 114) to each of the equipment assets 102. The controller 108 ensures that the correct amount of fuel is associated with the appropriate equipment asset 102 and personnel, thereby increasing accountability and transparency in fuel distribution. This information can be provided to the memory 112 via the controller 108 to track how much fuel is distributed to each asset 102.

The communication device 120 can communicate which assets 102 received fuel, how much fuel each of the assets 102 received, the personnel that dispensed the fuel to each of the assets 102, and in some embodiments times and/or dates of when the fuel was dispensed to each of the assets 102 to the rental interface system. This information can be recorded in the memory 112 and/or communicated to the rental interface system 122. As described above, this allows fuel tracking system 200 can track and record the chain-of-custody of fuel from the fuel tank 114 to each of the assets 102, even when in remote locations.

The fuel tracking systems 100, 200 can ensure that only approved equipment assets receive fuel from the tank 114. This can prevent users or personnel from dispensing fuel from the tank 114 into another asset (e.g., a personal vehicle) or container, thereby potentially stealing fuel. For example, the controller 108 of the fuel tracking systems 100, 200 can control the shut off device 116 to prevent dispensing of fuel from the tank 114 unless or until an asset identifier of an asset authorized to receive from the tank 114 is received (e.g., from the reader device 106 or the input device 110).

In some embodiments, the controller 108 can monitor data from the nozzle sensor(s) 128 to ensure that fuel is only dispensed to authorized assets 102, and not unauthorized assets or containers (such as personal vehicles, other equipment assets that are not rented, fuel containers, etc.). In one example, the nozzle sensor 128 includes an accelerometer that measures movements (or accelerations) of the nozzle sensor 128 (and, therefore, the nozzle 118) in different directions or around different axes. The measured movements can be sent to the controller 108, which can examine the measurement movements to determine whether the nozzle 118 was lowered or angled to be inserted into the fuel filler neck or fuel filler port in a first asset 102A, then raised or angled to be removed from the fuel filler neck or fuel filler port in that asset 102A, then lowered or angled again to dispense fuel before being returned to a position of rest (e.g., returned to a nozzle cradle or holder at the fuel tank 114 or vehicle 202) or before scanning another valid asset identifier on an asset identification device 104. This type of movement of the nozzle 118 can indicate that the personnel dispensing the fuel with the nozzle 118 is attempting to dispense the fuel to multiple assets or containers in addition to at least one authorized asset 102.

In another example, the nozzle sensor 128 includes one or more than one pressure sensors that measure fuel pressures in the nozzle 118 and/or the hose 126. The measured pressures can be sent to the controller 108, which can examine the measured pressures to determine whether the nozzle 118 was used (or attempted to be used) to fill any unauthorized assets and/or containers. For example, if the controller 108 receives the asset identifier of an authorized asset 102, the controller 108 permits the nozzle 118 to dispense fuel to the asset 102. The measured pressures increase during fueling of the authorized asset 102 but then decrease once the nozzle 118 is no longer actuated to dispense fuel. If the measured pressures increase again before the controller 108 receives an asset identifier from another authorized asset, then the controller 108 can determine that the nozzle 118 is being used or is likely being used to fuel an unauthorized asset or container. As a result, the controller 108 can activate the shut off device 116 and stop dispensing of fuel from the nozzle 118.

In another example, the nozzle sensor 128 includes one or more than one flow rate sensors that measure rates of fuel flow out of the nozzle 118 and/or through the hose 126. The measured flow rates can be sent to the controller 108, which can examine the measured flow rates to determine whether the nozzle 118 was used (or attempted to be used) to fill any unauthorized assets and/or containers. For example, if the controller 108 receives the asset identifier of an authorized asset 102, the controller 108 permits the nozzle 118 to dispense fuel to the asset 102. The measured flow rates increase during fueling of the authorized asset 102 but then decrease once the nozzle 118 is no longer actuated to dispense fuel. If the measured flow rates increase again before the controller 108 receives an asset identifier from another authorized asset, then the controller 108 can determine that the nozzle 118 is being used or is likely being used to fuel an unauthorized asset or container. As a result, the controller 108 can activate the shut off device 116 and stop dispensing of fuel from the nozzle 118.

The controller 108 can examine outputs from multiple different nozzle sensors 128 to determine whether any unauthorized fuel dispensing from the nozzle 118 is occurring. For example, the controller 108 may examine both (a) accelerations measured by an accelerometer as described above and (b) the fuel pressures measured by a pressure sensor or the fuel flow rates measured by a flow rate sensor. If both the (a) accelerations and (b) the fuel pressures or the fuel flow rates indicate that the nozzle 118 is being moved between different locations to fuel different locations without obtaining asset identifiers from authorized assets 102 before each fueling begins, then the controller 108 can stop fueling using the shut off device 116. Otherwise, if the controller 108 receives an asset identifier prior to fueling (as indicated by the output from the sensors 128), then the controller 108 can permit fueling to proceed via the nozzle 118.

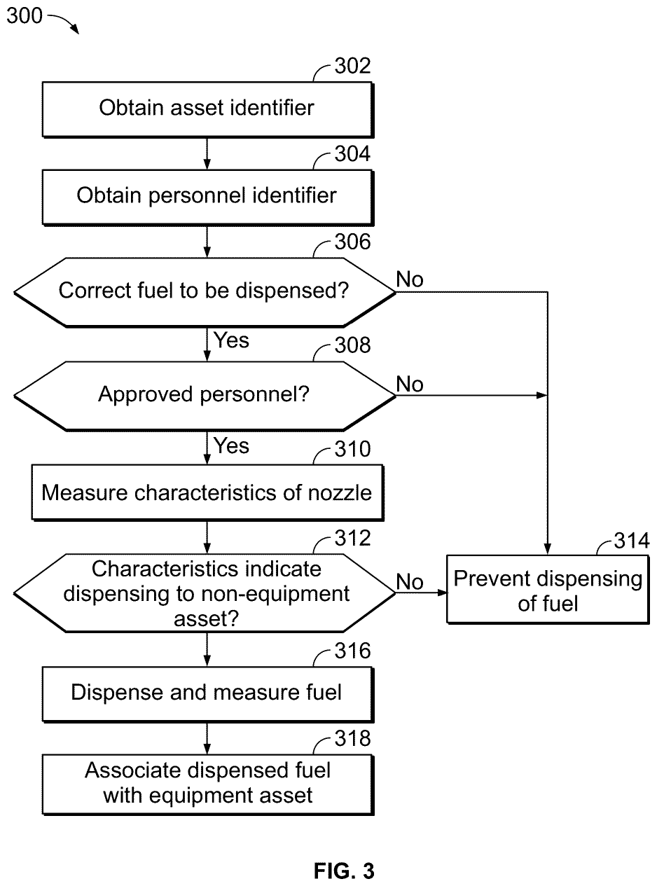

FIG. 3 illustrates a flow chart of one example of a method 300 for tracking distribution of fuel. The method 300 can represent operations performed by the fuel tracking systems described herein. At 302, an asset identifier is obtained. The asset identifier may be obtained by reading the identifier from an asset identification device. For example, the asset identifier may be stored in the asset identification device 104 (e.g., in an RFID tag), may be represented by a bar code or QR code, or the like, which is read, scanned, or otherwise obtained by the reader device.

At 304, a personnel identifier is obtained. The personnel identifier can be obtained based on the reader device scanning a tag (e.g., RFID tag) or bar code held or worn by the personnel attempting to fuel one or more the one equipment assets 102, or by the personnel manually inputting the identifier into the input device 110. In some embodiments, 302 and 304 may occur in a different order (i.e., 304 before 302), concurrently, or simultaneously.

At 306, a decision is made as to whether the fuel that is attempted to be dispensed to the identified asset is the correct or proper fuel. The controller 108 can examine the correct fuels for different assets 102 (based on the asset identifiers) as stored in the memory 112 and decide whether the asset identifier received at 302 is associated with the same fuel in the memory 112 as is about to be dispensed to the asset 102. If the asset identifier received at 302 is associated with the same fuel as in the tank 114, then flow of the method 300 can proceed toward 308. Otherwise, flow of the method 300 can proceed toward 314.

At 308, a decision is made as to whether the personnel identified at 304 is authorized to dispense fuel. The controller 108 can cross-reference the personnel identifier received 304 at with stored data indicating authorized users or personnel. If the personnel are not authorized, flow of the method 300 can proceed toward 314. If the personnel are authorized, the method 300 can continue toward 310. Optionally, the order of 306 and 308 may be switched, or these operations can be performed concurrently or simultaneously.

At 310, one or more than one of the characteristics of the fuel dispensing nozzle are measured. These characteristics can include fuel pressure, rate of fuel flow, and movements of the nozzle 118. This data collected by the nozzle sensor(s) 302 can be sent to the controller 108 for analysis. The sensor data can be collected before, during, and/or after dispensing fuel or filling the fuel tank of at least one equipment asset 102 to determine whether the nozzle 118 is being used again (or is attempted to be used again) to dispense fuel to another location (e.g., into another equipment asset 102, into another asset that is not an equipment asset 102, and/or a container) without authenticating or authorizing the other location (e.g., the other asset 102, a non-asset 102, or container) before dispensing or attempting to dispense the fuel.

At 312, a decision is made as to whether the characteristic(s) measured at 310 indicate the fuel is being dispensed (or attempted to be dispensed) into an unauthorized location (e.g., an asset other than an authorized asset or a container). The controller 108 can analyze the data from the nozzle sensor(s) 302 to determine whether the fuel is being dispensed to a non-equipment asset (e.g., an asset or container other than an equipment asset 102 that is authorized to receive fuel). This analysis can include examining the movements of the nozzle 118, changes in fuel pressure in the nozzle 118 and/or hose 126, and/or variations in flow rate of the fuel through and/or out of the nozzle 118 and/or hose 126. If the characteristics indicate potential fuel theft or misuse, the method 300 can proceed toward 314. If the characteristics do not indicate any issues or potential theft or misuse, the method 300 can continue toward 316.

At 314, dispensing of fuel is prevented. If the controller 108 determines that the fuel is being dispensed to a non-equipment asset and/or if the personnel dispensing the fuel are not approved to dispense the fuel, the method 300 can prevent dispensing (or continued dispensing) of fuel, such as by activating the shut off device 116. The shut off device 116 can lock the fuel nozzle 118 or otherwise prevent any further fuel from being dispensed. This helps ensure that fuel is only dispensed to authorized equipment assets 102 and personnel, thereby enhancing the security and accuracy of the fuel distribution process. Flow of the method 300 can terminate, or can return to one or more other operations (e.g., 302). In one example, the method 300 can return to 302, 306, 310, 312, and 314 or 316 without re-verifying the personnel (e.g., obtaining the personnel identifier at 304 and checking to ensure the personnel is approved at 308). Stated differently, the personnel dispensing the fuel may not need to be repeatedly re-authorized at 304 and 308 unless or until the nozzle 118 is returned to a resting state or position, or a designated period of time has expired (e.g., fifteen minutes or so, to avoid the personnel having to repeatedly re-authorize themselves when refilling several different authorized equipment assets 102).

At 314, fuel is dispensed from the tank 114 to the authorized equipment asset 102 by the authorized personnel. The dispensing of fuel from the fuel nozzle 118 to the equipment assets 102 occurs while at least one of the nozzle sensors 302 measures the amount of fuel dispensed. The data collected during this operation may be communicated to the controller 108, communicated to the rental interface system 122, stored in the memory 112, and/or stored in the memory 124 for maintaining precise records of fuel distribution.

At 318, the amount of dispensed fuel is associated with the equipment asset 102. The controller 108 can examine the data collected from the previous operations to ensure that the correct amount of fuel is associated with the equipment asset 102 that is rented for accurate invoicing to the appropriate customer or according to the correct rental contract.

The stopping of fuel from being dispensed into an unauthorized asset or container is a practical application of the invention that enhances security, accountability, and operational efficiency in fuel distribution. This feature is achieved through the integration of a reader device, asset identification devices, and a controller, which work together to ensure that fuel is only dispensed to authorized equipment assets and personnel.

When the reader device 106 scans the asset identification device 104 attached to an equipment asset 102, it obtains a unique asset identifier. Simultaneously, the input device 110 captures the personnel identifier of the individual responsible for dispensing the fuel. This information is transmitted to the controller 108, which cross-references the received identifiers with stored data in the memory 112 to verify the authenticity and authorization of both the equipment asset and the personnel.

If the controller 108 determines that the asset identifier or personnel identifier does not match the stored data, or if either identifier is missing, it activates the shut off device 116 integrated with the fuel nozzle 118. The shut off device 116 locks the nozzle, preventing any fuel from being dispensed. This mechanism ensures that fuel is only dispensed to authorized equipment assets and personnel, thereby preventing unauthorized access to fuel.

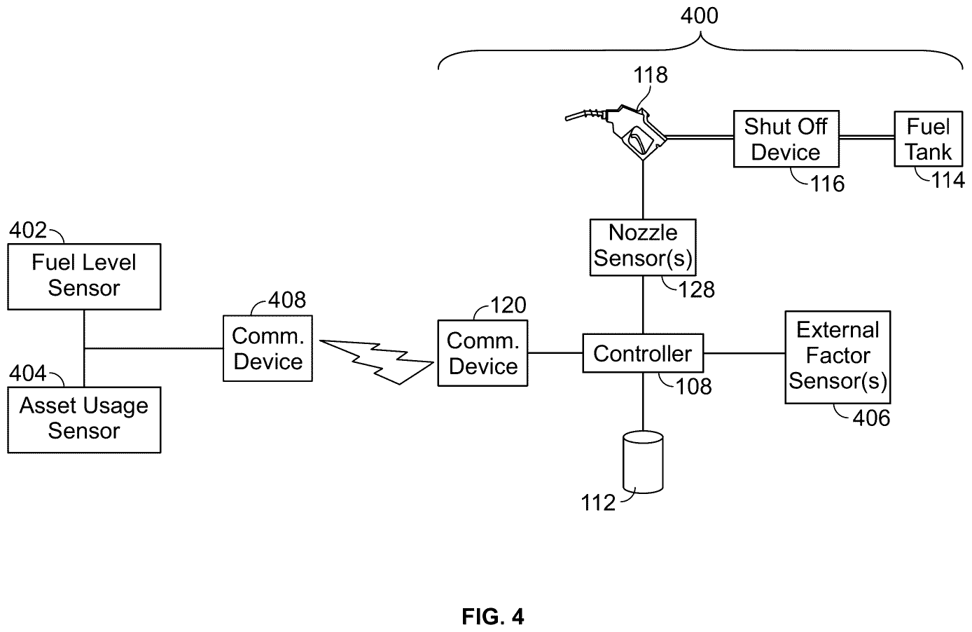

FIG. 4 illustrates another example of a fuel tracking system 400. The fuel tracking system 400 can include at least some of the same or similar components as the fuel tracking systems 100 and/or 200. For example, the fuel tracking system 400 can include the controller 108, the nozzle sensor(s), the memory 112, and/or the communication device 120. The system 400 can in some embodiments include one or more than one external factor sensors 506, described herein. The system 400 can integrate data output by various sensors and communication devices to track and monitor fuel levels, asset usage, nozzle activity, external factors, and the like, for monitoring operation of equipment assets 102 for deterioration over time, for reducing or eliminating theft of fuel, or the like. The system 500 can provide real-time data insights into the distribution of fuel to increase the accuracy and efficiency of managing distribution of fuel to the equipment assets 102, as well as reduce fuel loss to theft and monitor the equipment assets 102 for maintenance needs.

A fuel level sensor 502 can measure the amount of fuel present in a fuel tank of an equipment asset 102. Examples of the fuel level sensor 502 can include float sensors, capacitive sensors, ultrasonic sensors, resistive sensors, radar or microwave sensors, or the like, which are located in fuel tanks of the equipment assets 102. In some embodiments, the fuel level sensor 502 is not in the fuel tank. For example, the fuel level sensor 502 may sense the pressure of the fuel in a line (e.g., hose, conduit, or the like). In another example, the fuel level sensor 502 may read the amount of fuel by reading signals communicated via a CAN bus of the asset 102. The fuel level sensor 502 can provide real-time information on the amount of fuel in a fuel tank of an equipment asset 102. The fuel level sensor 502 can outputs signals to the controller 108 that indicate the amount of fuel carried by an equipment asset 102. The controller 108 can use the information to monitor fuel usage by the equipment asset 102.

An asset usage sensor 404 can measure various parameters related to the usage of the equipment assets 102. The asset usage sensor 404 can track data such as engine RPMs, duration of operation at certain RPMs, hours of operation, and distance traveled. The asset usage sensor 404 can include one or more than one tachometers, dynamometer, engine control unit, clocks (to track hours of operation), odometers, etc. This data can be used by the controller 108 for correlating fuel usage with activity of the equipment assets 102. The asset usage sensor 404 outputs this data to the controller 108, which uses the information to generate detailed reports on asset usage and fuel consumption.

External factor sensor(s) 406 can measure environmental conditions that may impact fuel burn rates. The external factor sensor(s) 406 can track weather conditions, temperature, humidity, and other relevant factors. For example, the external factor sensor(s) 406 can include thermometers, barometers, hygrometers, or the like. The external factor sensor(s) 406 can generate signals indicative of the sensed environmental conditions and send the signals to the controller 108. The external factor sensor(s) 406 can be in the same location as the nozzle sensor(s) 128 and/or in the same location as the equipment asset 102. For example, one or more than one of the external factor sensors 406 can be coupled with the equipment asset 102, one or more than one of the external factor sensors 406 can be coupled with the fuel nozzle 118, and/or one or more than one of the external factor sensors 406 can be coupled with the fuel tank 114, and so on.

A communication device 408 can be communicatively coupled with the sensor(s) 402, 404, and/or 406 that are remotely located from (or not directly wired to) the controller 108. For example, the sensors 402, 404, and/or 406 that are remote from the controller 108 can be connected with the communication device 408 via wired and/or wireless connections. The communication device 408 may be similar or identical to the communication device 120. For example, the communication device 408 can represent one or more than one modems, transceivers, transmitters, or the like. The communication device 408 can generate and send signals to the controller 108 via the communication device 120 that indicate the data that is or was sensed by the sensors 402, 404, and/or 406.

The controller 108 can receive data from the fuel level sensor(s) 402, asset usage sensor(s) 404, and/or the external factor sensor(s) 406, communication devices 408 and 120, and the nozzle sensor 302. The controller 108 can examine this data to track and compare the amount of fuel that an equipment asset 102 receives with the amount of fuel that the equipment asset 102 is expected to be using or consuming. The amount of fuel that the equipment asset 102 receives can be tracked as described above. The amount of fuel that the equipment asset 102 is expected to use or consume can be estimated by the controller 108 based on the output from the fuel level sensors 402, the usage sensors 404, and/or the external factor sensors 406.

The controller 108 can calculate an estimate of the amount of fuel that the equipment asset 102 should consume over a designated period of time (e.g., one day, one week, one month, etc.). This estimate can be calculated by the controller 108 calculating differences in the fuel levels measured by the fuel level sensor 402, the operational usage of the equipment asset 102, and/or the environmental conditions measured by the external factor sensor(s) 406. For example, the change (e.g., drop) in fuel level measured by the fuel level sensor 402 can be added to a calculated consumption amount of the fuel that the equipment asset 102 is expected to consume due to the operational usage of the equipment asset 102 and/or to a calculated evaporation amount of the fuel that is expected to evaporate from the tank of the equipment asset 102 based on environmental conditions. The controller 108 can estimate the calculated consumption amount based on usage of the equipment asset 102 by estimating larger amounts of fuel consumed due to the equipment asset 102 operating at greater RPMs for longer, the equipment asset 102 operating in hotter conditions, the equipment asset 102 operating in drier conditions, etc., compared to the equipment asset 102 operating at lesser RPMs and/or at greater RPMs for less time, the equipment asset 102 operating in cooler conditions, and/or the equipment asset 102 operating in more humid conditions.

The controller 108 can compare this calculated consumption amount with the amount of fuel dispensed to the equipment asset 102. If there is a discrepancy, such as the calculated consumption amount being more than 10%, more than 20%, more than 30%, etc. (in different embodiments) different than the amount of fuel dispensed to the equipment asset 102, then the controller 108 can decide that potential theft of fuel from the equipment asset 102 has occurred, or the equipment asset 102 is in need for repair, maintenance, or inspection. In response, the controller 108 can generate and communicate a signal to the rental interface system 122 to notify the rental interface system 122. Maintenance, inspection, and/or repair of the equipment asset 102 may then be performed. If the equipment asset 102 is found to be operating properly, then additional distributions of fuel to the equipment asset 102 over time can be tracked to determine whether theft of fuel is occurring. For example, if the discrepancies continue and the equipment asset 102 is operating properly, then the controller 108 can determine that fuel theft is likely occurring.

In some embodiments, the controller 108 can track the amount of fuel held in an equipment asset 102 following termination of usage of the equipment asset 102 and the amount of fuel held in the same equipment asset 102 prior to beginning a subsequent usage of the equipment asset 102. For example, at the end of a first day when the equipment asset 102 is deactivated, shut off, etc., the controller 108 can receive the amount of fuel held in the fuel tank 114 of the equipment asset 102 from the fuel level sensor 402. At or prior to the beginning of a second day that the same equipment asset 102 is to be activated or turned on (where the first and second days may or may not be consecutive days), the controller 108 can receive the amount of fuel held in the same fuel tank 114 from the fuel level sensor 402. In some embodiments, the controller 108 can estimate or calculate how much fuel is expected to evaporate from the fuel tank 114 due to weather conditions. This estimation or calculation can be based on empirical measurements, distillation curves, vapor pressures, and the like.

The controller 108 can estimate how much fuel should be in the fuel tank 114 after the end of the first day (e.g., when the equipment asset 102 is deactivated), compare this estimate to the amount of fuel that is in the fuel tank 114 at or prior to the beginning of the second day (e.g., when the equipment asset 102 is first activated after the previous measurement of the fuel tank 114 was performed), and determine whether there is a discrepancy between these amounts. The amount of fuel that is expected to be in the fuel tank 114 at or prior to activation of the equipment asset 102 may be reduced due to the estimated or calculated amount of evaporation. If the amount of fuel in the fuel tank 114 at the second day is at least 3% less, at least 5% less, or the like, then the controller 108 can determine that there is a discrepancy between the measured amounts of fuel. Otherwise, the controller 108 can determine that there is no discrepancy between the measured amounts of fuel.

Responsive to identifying this discrepancy, the controller 108 can decide that potential theft of fuel from the equipment asset 102 has occurred, or the equipment asset 102 is in need for repair, maintenance, or inspection. For example, the controller 108 may determine that the fuel tank 114, the fuel lines, etc., may need to be inspected for leaks. The controller 108 can generate and communicate a signal to the rental interface system 122 to notify the rental interface system 122. Maintenance, inspection, and/or repair of the equipment asset 102 may then be performed.

The controller 108 also can track fuel consumption and/or loss for one or more than one of the equipment assets 102 over time. If the amount of fuel consumed by the controller 108 changes over time while considering usage of the controller 108, then this can indicate potential fuel theft, faults in the equipment asset 102, or deterioration of the equipment asset 102. If the equipment asset 102 exhibits a trend in increasing fuel consumption when normalizing the amount of fuel consumed for usage of the asset 102 and/or the weather conditions, then this can indicate a potential fault, failure, or need for maintenance or inspection of the asset 102. In response, the controller 108 can generate and communicate a signal to the rental interface system 122 to notify the rental interface system 122. Maintenance, inspection, and/or repair of the equipment asset 102 may then be performed.

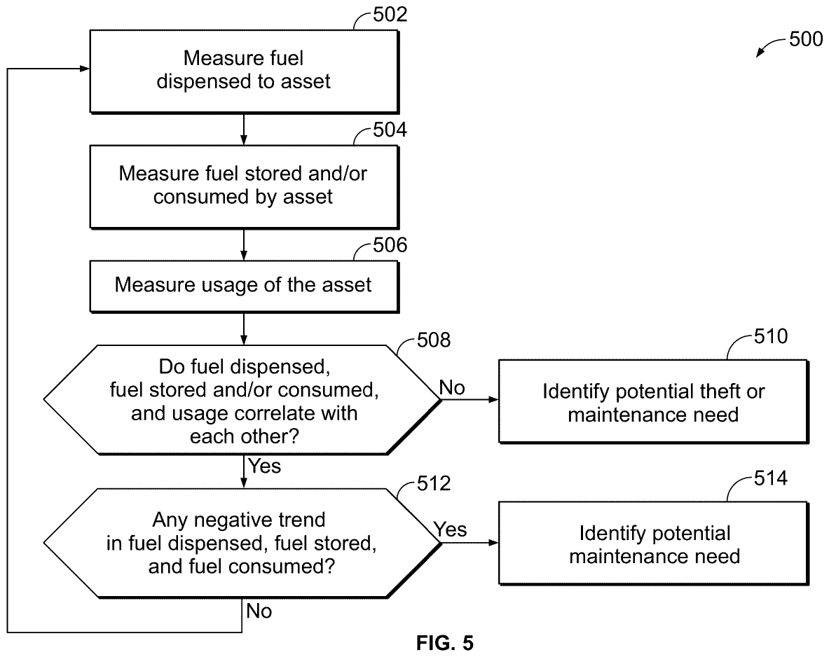

FIG. 5 illustrates a flow chart of one example of a method 500 for correlating fuel dispensed, fuel stored, and/or asset usage to identify potential theft or maintenance needs. At 502, fuel dispensed to an equipment asset is measured. This amount of fuel can be tracked as described above. At 504, the fuel stored and/or consumed by the asset is measured. The fuel stored and/or consumed by the asset 102 can be measured by comparing the measured fuel levels carried by the fuel tank of the asset 102 at different times.

At 506, usage of the asset is measured. The usage of the equipment asset 102 can be measured by the sensor 404 measuring various parameters related to the usage of the equipment asset 102, such as engine RPMs, hours of operation, and distance traveled. At 508, a decision is made as to whether the fuel dispensed, fuel stored and/or consumed, and asset usage correlate with each other. The controller 108 can examine the data collected from the operations to determine whether there is a correlation between the fuel dispensed, fuel stored and/or consumed, and the usage of the equipment asset 102. This examination can help identify discrepancies or irregularities in fuel usage, which can be indicative of fuel theft or misuse. If the data does not correlate, flow of the method 500 can proceed toward 510. If the data does correlate, flow of the method 500 can proceed toward 512.

At 510, potential theft or a need for maintenance of the asset is identified. Based on the analysis conducted at 508, the controller 108 can identify potential fuel theft or maintenance needs as more fuel is being consumed or lost relative to the amount of fuel dispensed to the asset 102. If the data indicates that the fuel dispensed does not match the fuel stored, consumed, and/or lost, or if the usage data does not correlate with the fuel usage, the controller 108 can flag the issue for further investigation. This can help maintain the security and accuracy of the fuel distribution process and ensuring that the equipment assets are operating efficiently. Flow of the method 500 can then terminate or return to another operation, such as 502.

At 512, a decision is made as to whether there is a negative trend in the amount of fuel dispensed, stored, and/or consumed by the asset. The controller 108 can track the amount of fuel used by the same equipment asset 102 over time, looking for trends or changes that may indicate that the equipment asset 102 needs inspection, repair, or maintenance. This can involve analyzing the data collected from the fuel level sensor 502, asset usage sensor 504, and other relevant sensors over time (e.g., several weeks, months, or the like) to identify any negative trends in fuel usage, such as the amount of fuel being consumed increasing over time, even when usage of the equipment asset 102 is not increasing. If such a negative trend is identified, flow of the method 500 can proceed toward 514. Otherwise, flow of the method 500 can return to another operation (e.g., 502) or can terminate.

At 514, a need for maintenance of the asset is identified. Based on the analysis conducted at 512, the controller 108 can decide that the equipment asset 102 may be in need of repair, inspection, or maintenance due to the asset 102 consuming more fuel that the asset 102 should be consuming if the asset 102 were operating without any deterioration or faults. The controller 108 can flag the issue for further investigation, such as by generating and sending a signal to the rental interface system 122. The rental interface system 122 can then schedule maintenance or repair of the asset 102. Flow of the method 500 can then terminate or return to another operation, such as 502.

The systems and methods described herein provide several practical applications of the inventive subject matter. For example, by preventing fuel from being dispensed into unauthorized assets or containers, the systems and methods reduce the risk of fuel theft and unauthorized use. This is particularly important in rental services, construction sites, and other industries where fuel is a valuable resource. The systems and methods track the personnel responsible for dispensing the fuel and the equipment assets receiving the fuel. This detailed tracking helps in identifying any discrepancies or irregularities in fuel usage, enhancing accountability and transparency in fuel distribution. By ensuring that only authorized equipment assets receive the correct type of fuel, the systems and methods help maintain the operational integrity and longevity of the equipment. This reduces the risk of equipment damage due to incorrect fuel types and minimizes downtime and repair costs.

The ability of the systems and methods to track fuel distribution accurately ensures that the correct amount of fuel is billed to the appropriate customer or rental contract. This helps prevent disputes and financial losses due to incorrect billing. In industries where fuel usage is subject to regulatory oversight, the detailed tracking and monitoring capabilities of the systems and methods help ensure compliance with fuel management regulations and reporting requirements. Overall, the stopping of fuel from being dispensed into unauthorized assets or containers is a practical and valuable application of the invention, providing significant benefits in terms of security, accountability, operational efficiency, and regulatory compliance.

Although embodiments of the inventive subject matter have been described with reference to specific example embodiments, it will be evident that various modifications and changes may be made to these embodiments without departing from the broader spirit and scope of the embodiments of the inventive subject matter. Accordingly, the specification and drawings are to be regarded in an illustrative rather than a restrictive sense.

The methods described herein do not have to be executed in the order described, or in any particular order. Moreover, various activities described with respect to the methods identified herein can be executed in serial or parallel fashion. Although ends to the flow charts may be shown in the flowcharts, the methods may be performed continuously.

In the foregoing description, it can be seen that various features are grouped together in a single embodiment for the purpose of streamlining the disclosure. This method of disclosure is not to be interpreted as reflecting an intention that the claimed examples require more features than are expressly recited in each claim. Rather, as the following claims reflect, inventive subject matter may lie in less than all features of a single disclosed embodiment. Thus, the following claims are hereby incorporated into the description, with each claim standing on its own as a separate embodiment.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more than one step within a method may be executed in different order (or concurrently) without altering the principles of the present disclosure. Further, although each of the embodiments is described above as having certain features, any one or more than one of those features described with respect to any embodiment of the disclosure can be implemented in and/or combined with features of any of the other embodiments, even if that combination is not explicitly described. In other words, the described embodiments are not mutually exclusive, and permutations of one or more than one embodiment with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more than one intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In this application, the term “processor” or the term “controller” may be replaced with the term “circuit.” The term processor or controller may refer to, be part of, or include: an ASIC; a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

In some examples, interface circuits between different components may include wired or wireless interfaces that are connected to a local area network (LAN), the Internet, a wide area network (WAN), or combinations thereof. The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The systems and methods described in this application may be partially or fully implemented by a special purpose computer created by configuring a general purpose computer to execute one or more than one particular function embodied in computer programs. The functional blocks and flowchart elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more than one operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

What is claimed is:

1. A fluid tracking system comprising:
a reader device configured to read a plurality of asset identification devices, the asset identification devices including a first asset identification device coupled to a first equipment asset and a second asset identification device coupled to a second equipment asset, the first equipment asset and the second equipment asset being different from each other, the first asset identification device configured to obtain a first unique asset identifier from the first equipment asset, the second asset identification device configured to obtain a second unique asset identifier from the second equipment asset that differs from the first unique asset identifier; and
a controller configured to receive data including a first amount of fluid dispensed to the first equipment asset from one or more fluid dispensers, a second amount of the fluid dispensed to the second equipment asset from the one or more fluid dispensers, the first unique asset identifier, and the second unique asset identifier,
the controller configured to track custody of the fluid from the one or more fluid dispensers to the first equipment asset and to the second equipment asset for monitoring the first amount of the fluid dispensed to the first equipment asset and for monitoring the second amount of the fluid dispensed to the second equipment asset, the controller configured to identify one or more of (a) theft of the fluid or (b) a fault with the first equipment asset, with the second equipment asset, with a first engine of the first equipment asset, or with a second engine of the second equipment asset based on the custody of the fluid that is tracked.

2. The fluid tracking system of claim 1, wherein the one or more fluid dispensers include a fuel vehicle configured to haul fuel as the fluid from a stationary fuel pump station to a remote location where the first equipment asset and the second equipment asset are located, the reader device configured to be coupled with the fuel vehicle to read the asset identification devices and obtain the first unique asset identifier and the second unique asset identifier at the remote location, and further comprising:
a nozzle sensor coupled with the fuel vehicle and configured to measure the first amount of the fluid dispensed to the first equipment asset and the second amount of the fluid dispensed to the second equipment asset, the nozzle sensor configured to directly or indirectly output the amounts of the fluid dispensed to the controller.

3. The fluid tracking system of claim 1, further comprising:
a nozzle sensor configured to be coupled with a nozzle coupled with the one or more fluid dispensers, the nozzle sensor configured to measure one or more characteristics of the nozzle or the fluid, the controller configured to determine whether any of the fluid dispensed from the one or more fluid dispensers is dispensed to a non-equipment asset based on the one or more characteristics.

4. The fluid tracking system of claim 3, wherein the controller is configured to determine whether the fluid that is dispensed to a non-equipment asset is stolen, dispensed into a container other than the first equipment asset and or the second equipment asset, or dispensed into equipment or a vehicle other than the first equipment asset and the second equipment asset based on the one or more characteristics.

5. The fluid tracking system of claim 4, wherein the nozzle sensor includes an accelerometer configured to measure movements of the nozzle as the one or more characteristics,
the controller configured to examine the movements of the nozzle that are measured to determine whether (a) the nozzle moved from at least one of the fluid dispensers to the first equipment asset or the second equipment asset to dispense the fluid and then back to the at least one of the fluid dispensers or (b) the nozzle moved from at least one of the first equipment asset or the second equipment asset and then to the non-equipment asset to dispense the fluid before being returned to the at least one of the fluid dispensers.

6. The fluid tracking system of claim 4, wherein the nozzle sensor includes a pressure sensor configured to measure fluid pressures within one or more of the nozzle or a hose connecting the nozzle to at least one of the fluid dispensers as the one or more characteristics,
the controller configured to examine the fluid pressures to determine whether (a) the nozzle moved from at least one of the fluid dispensers to the first equipment asset or the second equipment asset to dispense the fluid and then back to the at least one of the fluid dispensers or (b) the nozzle moved from at least one of the first equipment asset or the second equipment asset and then to the non-equipment asset to dispense the fluid before being returned to the at least one of the fluid dispensers.

7. The fluid tracking system of claim 4, wherein the nozzle sensor includes a flow rate sensor configured to measure rates of fluid flow out of the nozzle as the one or more characteristics,
the controller configured to examine the rates of fluid flow to determine whether (a) the nozzle moved from at least one of the fluid dispensers to the first equipment asset or the second equipment asset to dispense the fluid and then back to the at least one of the fluid dispensers or (b) the nozzle moved from at least one of the first equipment asset or the second equipment asset and then to the non-equipment asset to dispense the fluid before being returned to the at least one of the fluid dispensers.

8. The fluid tracking system of claim 1, wherein the controller is configured to track the amounts of the fluid dispensed to each of the first equipment asset and the second equipment asset, the controller configured to communicate with the first equipment asset and the second equipment asset to monitor usage of the first equipment asset and the second equipment asset.

9. The fluid tracking system of claim 8, wherein the controller is configured to identify potential theft of the fluid by comparing the amounts of the fluid dispensed to each of the first equipment asset and the second equipment asset with the usage of each of the first equipment asset and the second equipment asset.

10. The fluid tracking system of claim 8, wherein the controller is configured to identify one or more of the first equipment asset or the second equipment asset as in need for repair, maintenance, or inspection by comparing the amounts of fluid dispensed to each of the first equipment asset and the second equipment asset with the usage of each of the first equipment asset and the second equipment asset.

11. The fluid tracking system of claim 1, wherein the controller is configured to identify a type of the fluid that each of the first equipment asset and the second equipment asset can use from the first unique asset identifier and the second unique asset identifier read by the reader device, the controller configured to control a fluid nozzle to prevent dispensing of the fluid to at least one of the first equipment asset or the second equipment asset responsive to determining that the fluid is different from the fluid type usable by the at least one of the first equipment asset or the second equipment asset.

12. A method for tracking distribution of fluid, the method comprising:
reading a first asset identification device coupled to a first equipment asset using a reader device to obtain a first unique asset identifier of the first equipment asset;
reading a second asset identification device coupled to a second equipment asset using the reader device to obtain a second unique asset identifier of the second equipment asset, the second equipment asset being different from the first equipment asset;
receiving, at a controller, a first amount of the fluid dispensed to the first equipment asset from one or more fluid dispensers and the first unique asset identifier;
receiving, at the controller, a second amount of the fluid dispensed to the second equipment asset from one or more fluidfluid dispensers and the second unique asset identifier;
tracking custody of the fluid from the one or more fluid dispensers to the first equipment asset and to the second equipment asset for monitoring the first amount of the fluid dispensed to the first equipment asset and for monitoring the second amount of the fluid dispensed to the second equipment asset; and
identifying one or more of (a) theft of the fluid or (b) a fault with the first equipment asset, with the second equipment asset, with a first engine of the first equipment asset, or with a second engine of the second equipment asset based on the custody of the fluid that is tracked.

13. The method of claim 12, wherein the one or more fluid dispensers include a fuel vehicle configured to haul fuel from a stationary fuel pump station to a remote location where the first equipment asset and the second equipment asset are located, the reader device coupled with the fuel vehicle to read the first asset identification device and the second asset identification device, and to obtain the first unique asset identifier and the second unique asset identifier at the remote location, the method further comprising:
measuring the first amount of the fuel dispensed to the first equipment asset and the second amount of the fuel dispensed to the second equipment asset at the remote location using a nozzle sensor; and
directly or indirectly communicating the first amount of the fuel and the second amount of the fuel to the controller from the nozzle sensor.

14. The method of claim 12, further comprising:
measuring one or more characteristics of a nozzle that dispenses the fluid or of the fluid using a nozzle sensor; and
determining whether the first amount of the fluid and the second amount of the fluid that is dispensed from the one or more fluid dispensers is dispensed to at least one of the first equipment asset, the second equipment asset, or to a non-equipment asset based on the one or more characteristics.

15. The method of claim 14, wherein the one or more characteristics include movements of the nozzle measured using an accelerometer, the method further comprising:
examining the movements of the nozzle that are measured to determine whether (a) the nozzle moved from at least one of the fluid dispensers to the first equipment asset or the second equipment asset to dispense the fluid and then back to the at least one of the at least one of the fluid dispensers or (b) the nozzle moved from at least one of the first equipment asset or the second equipment asset then to the non-equipment asset to dispense the fluid before being returned to the at least one of the fluid dispensers.

16. The method of claim 14, wherein the one or more characteristics include fluid pressures within one or more of a nozzle or a hose connecting the nozzle to at least one of the fluid dispensers, the method further comprising:
examining the fluid pressures to determine whether (a) the nozzle moved from at least one of the fluid dispensers to the first equipment asset or the second equipment asset to dispense the fluid and then back to the at least one of the fluid dispensers or (b) the nozzle moved from at least one of the first equipment asset or the second equipment asset to the non-equipment asset to dispense the fluid before being returned to the at least one of the fluid dispensers.

17. A fluid tracking system comprising:
a reader device coupled with a fluid dispenser, the reader device configured to interrogate an asset identification device to obtain a unique asset identifier of a rental equipment asset;
an input device coupled with the fluid dispenser, the input device configured to receive a personnel identifier that uniquely identifies a person that distributed fluid to the rental equipment asset from the fluid dispenser;
a nozzle sensor coupled with a nozzle of the fluid dispenser from which the fluid is dispensed, the nozzle sensor configured to monitor one or more characteristics of the nozzle or the fluid dispensed from the nozzle; and
a controller configured to receive the unique asset identifier, the personnel identifier, and the one or more characteristics of the nozzle or the fluid to track an amount of fluid dispensed to the rental equipment asset and determine whether a portion of the fluid dispensed from the fluid dispenser is stolen.

18. The fluid tracking system of claim 17, wherein the controller is configured to identify a usable type of the fluid that the rental equipment asset can use based on the unique asset identifier, the controller configured to change a state of a value coupled with the nozzle to prevent dispensing of the fluid based on the usable type of the fluid that the rental equipment asset can use and a dispensed type of the fluid that is dispensed from the fluid dispenser.

19. The fluid tracking system of claim 17, wherein the nozzle sensor is configured to measure one or more of movements of the nozzle, fluid pressure within the nozzle or a hose connected to the nozzle, or a rate of flow of the fluid from the nozzle as the one or more characteristics.

20. The fluid tracking system of claim 17, wherein the controller is configured to determine whether the fluid that is dispensed is stolen, dispensed into a container other than the equipment asset, or is dispensed into equipment or a vehicle other than the equipment asset based on the one or more characteristics.
